(19) United States
(12) Patent Application Publication
(10) Pub. No.: US 2025/0275030 A1
(43) Pub. Date: Aug. 28, 2025

(54) CONSTANT ILLUMINANCE LIGHTING CONTROL DEVICE AND METHOD THEREOF

(71) Applicant: Xiamen PVTECH Co., Ltd., Xiamen (CN)

(72) Inventors: HAO YE, Xiamen (CN); FUXING LU, Xiamen (CN); CHENGQUAN XU, Xiamen (CN)

(73) Assignee: Xiamen PVTECH Co., Ltd., Xiamen (CN)

(21) Appl. No.: 19/017,757

(22) Filed: Jan. 12, 2025

(30) Foreign Application Priority Data
Feb. 23, 2024 (CN) 202410206118.3

(51) Int. Cl. H05B 47/11; H05B 47/16; H05B 47/165; H05B 47/175; H05B 47/19

(52) U.S. Cl. CPC H05B 47/11; H05B 47/16; H05B 47/165; H05B 47/19; H05B 47/196

(57) ABSTRACT

A constant illuminance lighting control device includes a light detecting module and a processing module. The light detecting module detects the illuminance of a target area, which is provided by a lighting device. The processing module includes a signal register, and stores a dimming signal corresponding to the illuminance of the target area in the signal register to serve as an initial dimming signal. The processing module executes a dimming signal tracking program to compare the illuminance of the target area with a target illuminance to generate an illuminance difference signal, and calculates a lighting compensation step size accordingly. The processing module generates a real-time dimming signal according to the step size, transmits this signal to the lighting device for dimming, and stores this signal in the signal register to replace the initial dimming signal. The dimming signal tracking program is repeatedly executed.

### BACKGROUND OF THE INVENTION

### 1. Field of the Invention

The present invention relates to a lighting control device, in particular to a constant illuminance lighting control device. The present invention further relates to the constant illuminance lighting control method of the device.

### 2. Description of the Prior Art

With advancements in technology, the intelligent lighting industry has been rapidly developed, introducing various new applications such as energy-efficient lighting, health-focused lighting, and personalized lighting. To imbue spaces with greater imagination and aesthetic appeal, diverse constant illuminance lighting solutions have emerged. Currently available constant illuminance lighting solutions primarily rely on sensors installed on lighting devices to control dimming. However, due to environmental or other influencing factors, these solutions are still unable to effectively maintain a stable constant illuminance in the target area, failing to meet actual requirements.

China Patent Publication No.: CN101124853A and China Patent Publication No.: CN111511071A also disclose improved dimming technologies but still fail to effectively resolve the aforementioned problems.

### SUMMARY OF THE INVENTION

One embodiment of the present invention provides a constant illuminance lighting control device, which includes a light detecting module and a processing module. The light detecting module detects the illuminance of a target area, and the illuminance of the target area is provided by a lighting device. The processing module includes a signal register, and stores a dimming signal corresponding to the illuminance of the target area to serve as an initial dimming signal. The processing module executes a dimming signal tracking program to compare the illuminance of the target area with a target illuminance to generate an illuminance difference signal, and calculates a lighting compensation step size according to the illuminance difference signal. The processing module further generates a real-time dimming signal according to the lighting compensation step size, transmits the real-time dimming signal to the lighting device for dimming, and stores the real-time dimming signal in the signal register to replace the initial dimming signal. The dimming signal tracking program is repeatedly executed until the illuminance of the target area is substantially equal to the target illuminance.

In one embodiment, when the illuminance difference signal exceeds a first threshold value, the lighting compensation step size is a first step size. When the illuminance difference signal is less than the first threshold value but greater than a second threshold value, the lighting compensation step size is a second step size. When the illuminance difference signal is less than the second threshold value but greater than a third threshold value, the lighting compensation step size is a third step size. When the illuminance difference signal is less than the difference between the third threshold value and the illuminance of the target area, the lighting compensation step size is a fourth step size.

In one embodiment, the first step size is greater than the second step size. The second step size is greater than the third step size. The third step size is greater than the fourth step size.

In one embodiment, the first step size is 1.1 to 1.6 times the second step size. The second step size is 1.2 to 2 times the third step size. The third step size is 2.5 to 6.5 times the fourth step size.

In one embodiment, when the illuminance of the target area is substantially equal to the target illuminance, the lighting device executes an automatic adjustment mode, such that the illuminance difference between the illuminance of the target area and the target illuminance is continuously less than a preset difference value.

Another embodiment of the present invention provides a constant illuminance lighting control method, which includes the following steps: detecting the illuminance of a target area via a light detecting module, wherein the illuminance of the target area is provided by a lighting device; storing a dimming signal corresponding to the illuminance of the target area in a signal register to serve as the initial dimming signal by a processing module; executing a dimming signal tracking program via the processing module to compare the illuminance of the target area with a target illuminance in order to generate an illuminance difference signal; calculating a lighting compensation step size according to the illuminance difference signal, generating a real-time dimming signal based on the lighting compensation step size, and transmitting the real-time dimming signal to the lighting device for dimming by the processing module; and storing the real-time dimming signal in the signal register to replace the initial dimming signal, and repeatedly executing the dimming signal tracking program by the processing module until the illuminance of the target area is substantially equal to the target illuminance.

In one embodiment, when the illuminance difference signal exceeds a first threshold value, the lighting compensation step size is a first step size. When the illuminance difference signal is less than the first threshold value but greater than a second threshold value, the lighting compensation step size is a second step size. When the illuminance difference signal is less than the second threshold value but greater than a third threshold value, the lighting compensation step size is a third step size. When the illuminance difference signal is less than the difference between the third threshold value and the illuminance of the target area, the lighting compensation step size is a fourth step size.

In one embodiment, the first step size is greater than the second step size. The second step size is greater than the third step size. The third step size is greater than the fourth step size.

In one embodiment, the first step size is 1.1 to 1.6 times the second step size. The second step size is 1.2 to 2 times the third step size. The third step size is 2.5 to 6.5 times the fourth step size.

In one embodiment, the method further includes the following step: executing an automatic adjustment mode by the lighting device when the illuminance of the target area is substantially equal to the target illuminance, such that the illuminance difference between the target area and the target illuminance is continuously less than a preset difference value.

The constant illuminance lighting control device and the method thereof in accordance with the embodiments of the present invention may have the following advantages:

(1) In one embodiment of the present invention, the constant illuminance lighting control device includes a light detecting module and a processing module. The light detecting module detects the illuminance of a target area, and the illuminance of the target area is provided by a lighting device. The processing module includes a signal register, and stores a dimming signal corresponding to the illuminance of the target area to serve as an initial dimming signal. The processing module executes a dimming signal tracking program to compare the illuminance of the target area with a target illuminance to generate an illuminance difference signal, and calculates a lighting compensation step size according to the illuminance difference signal. The processing module further generates a real-time dimming signal according to the lighting compensation step size, transmits the real-time dimming signal to the lighting device for dimming, and stores the real-time dimming signal in the signal register to replace the initial dimming signal. The dimming signal tracking program is repeatedly executed until the illuminance of the target area is substantially equal to the target illuminance. As described above, the constant illuminance lighting control device can execute a special dimming signal tracking program to enable the real-time dimming signal to track the dimming signal corresponding to the target illuminance with extremely small step sizes, which can achieve stepless dimming. Therefore, the constant illuminance lighting control device can achieve high performance to meet actual requirements.

(2) In one embodiment of the present invention, the constant illuminance lighting control device features a multi-step adjustment mechanism. When the illuminance difference signal exceeds a first threshold value, the lighting compensation step size is a first step size, wherein when the illuminance difference signal is less than the first threshold value but greater than a second threshold value, the lighting compensation step size is a second step size, wherein when the illuminance difference signal is less than the second threshold value but greater than a third threshold value, the lighting compensation step size is a third step size, wherein when the illuminance difference signal is less than a difference between the third threshold value and the illuminance of the target area, the lighting compensation step size is a fourth step size. Thus, the constant illuminance lighting control device can achieve precise stepless dimming, ensuring extremely smooth brightness transitions in the lighting device. Therefore, the constant illuminance lighting control device can effectively enhance the lighting effect of the lighting device. The first step size is greater than the second step size. The second step size is greater than the third step size. The third step size is greater than the fourth step size. Thus, the constant illuminance lighting control device can achieve precise stepless dimming, ensuring extremely smooth brightness transitions in the lighting device. Therefore, the constant illuminance lighting control device can effectively enhance the lighting effect of the lighting device.

(3) In one embodiment of the present invention, the lighting device can also execute an automatic adjustment mode. When the lighting device executes the automatic adjustment mode, the brightness thereof can appropriately vary to ensure that the illuminance difference between the target area and the target illuminance remains below a preset difference value. Consequently, the illuminance of the target area can be maintained at a constant illuminance state over an extended period so as to be the requirements of the user.

(4) In one embodiment of the present invention, the lighting device can also include a time control module, enabling the control module of the lighting device to actively adjust the brightness thereof in a preset variation pattern according to the settings of the time control module. As a result, the brightness of the lighting device can vary with changes in ambient lighting in order to make sure that the illuminance of the target area remains constant or follows a specific variation pattern. Thus, the lighting device can satisfy the requirements of various applications.

(5) In one embodiment of the present invention, the lighting device can also include a power monitoring module and a display module. Consequently, the control module of the lighting device can obtain operational status information such as current and voltage via the power monitoring module and display this information via the display module. This allows the user to directly access the energy consumption and other necessary details of the lighting device and take timely measures in case of operational anomalies.

(6) In one embodiment of the present invention, the design of the constant illuminance lighting control device and the lighting device is simple, achieving the desired effects without significantly increasing costs. Therefore, the constant illuminance lighting control device and the lighting device both demonstrate high practicality and align with future development trends.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of a constant illuminance lighting control device in accordance with a first embodiment of the present invention.

FIG. 2 is a block diagram of a lighting device in accordance with the first embodiment of the present invention.

FIG. 3 is a schematic view of a lighting device in accordance with the first embodiment of the present invention.

FIG. 4 is a block diagram of a constant illuminance lighting control device in accordance with a second embodiment of the present invention.

FIG. 5 is a block diagram of a lighting device in accordance with the second embodiment of the present invention.

FIG. 6 is a flowchart of a constant illuminance lighting control method in accordance with a fourth embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

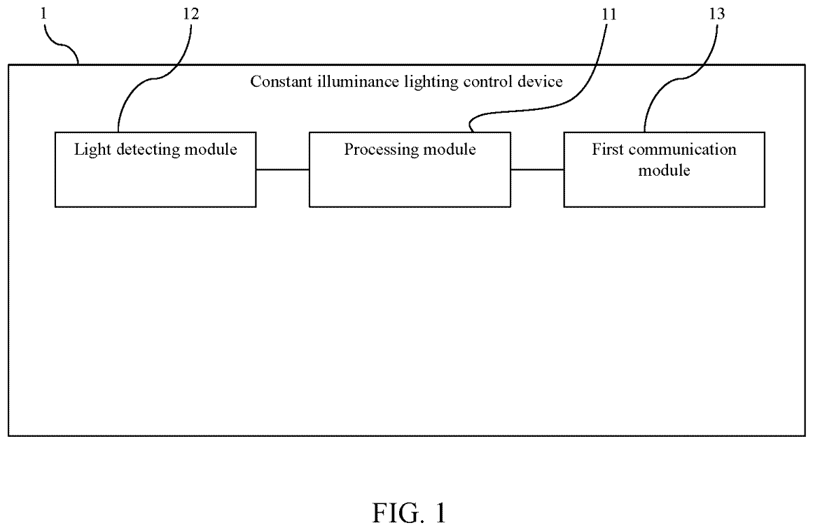

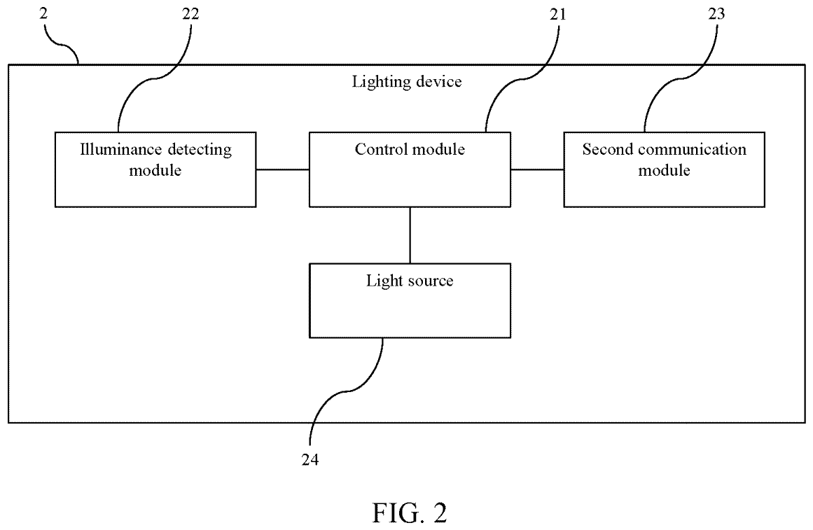

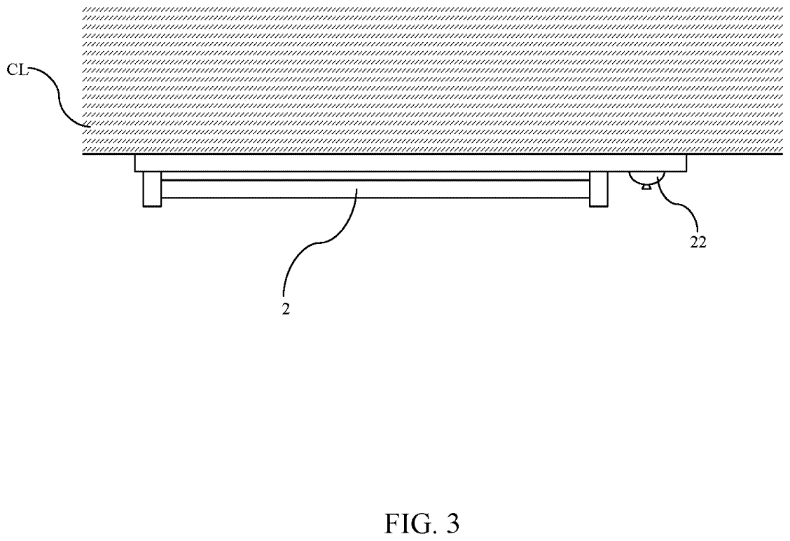

Please refer to FIG. 1, FIG. 2, and FIG. 3. FIG. 1 is a block diagram of a constant illuminance lighting control device in accordance with a first embodiment of the present invention. FIG. 2 is a block diagram of a lighting device in accordance with the first embodiment of the present invention. FIG. 3 is a schematic view of a lighting device in accordance with the first embodiment of the present invention. As shown in FIG. 1, FIG. 2, and FIG. 3, the constant illuminance lighting control device 1 includes a light detecting module 12, a processing module 11, and a first communication module 13.

The light detecting module 12 is connected to the processing module 11. In one embodiment, the light detecting module 12 can be an illuminance detector (which includes a photosensitive component), an illuminance meter, or other devices with illuminance detection functions. In another embodiment, the processing module 11 can be a microcontroller (MCU), a central processing unit (CPU), an application-specific integrated circuit (ASIC), a field-programmable gate array (FPGA), or other similar components.

The first communication module 13 is connected to the processing module 11. In one embodiment, the first communication module 13 can be a Bluetooth module, a Wi-Fi module, a ZigBee module, a 4G communication module, a 5G communication module, or other similar components.

The lighting device 2 includes an illuminance detecting module 22, a control module 21, a second communication module 23, and a light source 24. In this embodiment, the lighting device 2 can be a tube light that can be installed on the ceiling CL (or on a wall or other suitable locations) to provide illuminance to the target area. The illuminance detecting module 22 can be disposed on one side of the lighting device 2 or another suitable location.

The illuminance detecting module 22 is connected to the control module 21. In one embodiment, the illuminance detecting module 22 can be an illuminance detector (which includes a photosensitive component), an illuminance meter, or other devices with illuminance detection functions. In another embodiment, the control module 21 can be a microcontroller (MCU), a central processing unit (CPU), an application-specific integrated circuit (ASIC), a field-programmable gate array (FPGA), or other similar components.

The second communication module 23 is connected to the control module 21. In one embodiment, the second communication module 23 can be a Bluetooth module, a Wi-Fi module, a ZigBee module, a 4G communication module, a 5G communication module, or other similar components.

The light source 24 is connected to the control module 21. In one embodiment, the light source 24 can be a light-emitting diode (LED), an LED array, a light bulb, a lamp tube, or other similar components.

The constant illuminance lighting control device 1 can perform a dimming signal tracking mechanism. First, the light detecting module 12 detects the illuminance of the target area. The processing module 11 includes a signal register 111. Then, the processing module 11 stores the dimming signal corresponding to the illuminance of the target area in the signal register 111 as the initial dimming signal. Next, the processing module 11 executes a dimming signal tracking program to compare the illuminance of the target area with the target illuminance to generate an illuminance difference signal, and calculates a lighting compensation step size according to the illuminance difference signal. Afterward, the processing module 11 generates a real-time dimming signal according to the lighting compensation step size and transmits the real-time dimming signal via the first communication module 13. The control module 21 of the lighting device 2 can receive the real-time dimming signal via the second communication module 23, allowing the control module 21 of the lighting device 2 to adjust the light source 24 accordingly.

The processing module 11 stores the real-time dimming signal in the signal register 11 to replace the initial dimming signal. The processing module 11 can repeatedly execute the dimming signal tracking program until the illuminance of the target area is substantially equal to the target illuminance. As mentioned earlier, the processing module 11 can calculate the lighting compensation step size according to the illuminance difference signal. When the illuminance difference signal is greater than a first threshold value, the lighting compensation step size is a first step size. When the illuminance difference signal is less than the first threshold value but greater than a second threshold value, the lighting compensation step size is a second step size. When the illuminance difference signal is less than the second threshold value but greater than a third threshold value, the lighting compensation step size is a third step size. When the illuminance difference signal is less than the difference between the third threshold value and the illuminance of the target area, the lighting compensation step size is a fourth step size. The first step size is greater than the second step size. The second step size is greater than the third step size. The third step size is greater than the fourth step size. In one embodiment, the first step size is 1.1 to 1.6 times the second step size; the second step size is 1.2 to 2 times the third step size; the third step size is 2.5 to 6.5 times the fourth step size. In another embodiment, the first step size is 1.2 to 1.5 times the second step size; the second step size is 1.5 to 1.8 times the third step size; the third step size is 3 to 5 times the fourth step size.

For example, when the target illuminance LUX2 is greater than the illuminance of the target area LUX1, the processing module 11 can generate a real-time dimming signal to increase the brightness of the lighting device 2. In this embodiment, the first threshold value can be 130% of the illuminance of the target area LUX1, and the first step size can be 10 units, where one unit is 1/1000 of the maximum brightness of the light source 24 (this is just an example and can be adjusted as needed). When the illuminance difference signal exceeds 130% of the illuminance of the target area LUX1 (the first threshold value), the lighting compensation step size calculated by the processing module 11 is 10 units. The processing module 11 then generates the real-time dimming signal corresponding to 10 units and transmits the real-time dimming signal via the first communication module 13. The control module 21 of the lighting device 2 can receive the real-time dimming signal via the second communication module 23 to adjust the light source 24, and the real-time dimming signal is stored in the signal register 11 to replace the initial dimming signal. The processing module 11 then executes the dimming signal tracking program again to compare the illuminance LUX1 of the target area with the target illuminance LUX2 to generate an illuminance difference signal (the illuminance LUX1 of the target area has already been increased due to the previous dimming signal tracking program, which makes the illuminance LUX1 of the target area closer to the target illuminance LUX2), and calculates the lighting compensation step size according to the illuminance difference signal. Next, the processing module 11 generates the real-time dimming signal corresponding to 10 units according to the lighting compensation step size and transmits the real-time dimming signal via the first communication module 13. The control module 21 of the lighting device 2 can receive the real-time dimming signal through the second communication module 23 to adjust the light source 24, and the real-time dimming signal is stored in the signal register 11 to replace the initial dimming signal. The processing module 11 then continues to repeat the execution of the dimming signal tracking program.

In this embodiment, the second threshold value can be 120% of the illuminance LUX1 of the target area, and the second step size can be 8 units (this is just an example and can be adjusted as needed). When the illuminance difference signal is less than 130% of the illuminance LUX1 of the target area (the first threshold value) but greater than 120% of the illuminance LUX1 of the target area (the second threshold value), the lighting compensation step size calculated by the processing module 11 is 8 units. The processing module 11 then generates a real-time dimming signal corresponding to 8 units and transmits the real-time dimming signal via the first communication module 13. The control module 21 of the lighting device 2 can receive the real-time dimming signal via the second communication module 23 to adjust the light source 24, and the real-time dimming signal is stored in the signal register 11 to replace the initial dimming signal. The processing module 11 continues to repeat the execution of the dimming signal tracking program.

In this embodiment, the third threshold value can be 110% of the illuminance LUX1 of the target area, and the second step size can be 5 units (this is just an example and can be adjusted as needed). When the illuminance difference signal is less than 120% of the illuminance LUX1 (the second threshold value) but greater than 110% of the illuminance LUX1 (the third threshold value), the lighting compensation step size calculated by the processing module 11 is 5 units. The processing module 11 then generates a real-time dimming signal corresponding to 5 units and transmits the real-time dimming signal via the first communication module 13. The control module 21 of the lighting device 2 can receive the real-time dimming signal via the second communication module 23 to adjust the light source 24, and the real-time dimming signal is stored in the signal register 11 to replace the initial dimming signal. The processing module 11 continues to repeat the execution of the dimming signal tracking program.

In this embodiment, the fourth step size is 1 unit (this is just an example and can be adjusted as needed). When the illuminance difference signal is less than 110% of the illuminance LUX1 (the third threshold value) and the difference between the illuminance of the target area, the lighting compensation step size calculated by the processing module 11 is 1 unit. The processing module 11 then generates a real-time dimming signal corresponding to 1 unit and transmits the real-time dimming signal via the first communication module 13. The control module 21 of the lighting device 2 can receive the real-time dimming signal via the second communication module 23 to adjust the light source 24, and the real-time dimming signal is stored in the signal register 11 to replace the initial dimming signal. The processing module 11 then repeats the dimming signal tracking program after a preset time interval (the preset time interval can be a few seconds, such as 3 seconds, 5 seconds, etc., and can be adjusted according to actual needs). This preset time interval is designed to allow the light detecting module 12 to more stably detect the illuminance LUX1 of the target area.

When the illuminance difference signal is substantially equal to 0, the illuminance LUX1 of the target area is substantially equal to the target illuminance. At this point, the processing module 11 stops executing the dimming signal tracking program. Then, the user can remove the constant illuminance lighting control device 1. After the communication connection between the constant illuminance lighting control device 1 and the lighting device 2 is disconnected, the lighting device 2 executes the automatic adjustment mode, ensuring that the illuminance difference between the target area and the target illuminance remains less than a preset difference value. The illuminance detecting module 22 of the lighting device 2 can detect the illuminance of the target area, while the control module 21 can calculate the absolute value of the illuminance difference between the illuminance of the target area and the target illuminance. If this absolute value exceeds the preset difference value, the control module 21 adjusts the light source 24 (increases or decreases the brightness of the light source 24) to keep the absolute value always less than the preset difference value.

As previously stated, the constant illuminance lighting control device 1 can execute a specialized dimming signal tracking program, which allows the real-time dimming signal to track the dimming signal corresponding to the target illuminance with extremely small step sizes, thereby achieving stepless dimming. Consequently, the constant illuminance lighting control device 1 can achieve high performance to meet actual requirements.

Furthermore, the constant illuminance lighting control device 1 has a multi-step size adjustment mechanism. When the illuminance difference signal is greater than the first threshold value, the lighting compensation step size is the first step size. When the illuminance difference signal is less than the first threshold value but greater than the second threshold value, the lighting compensation step size is the second step size. When the illuminance difference signal is less than the second threshold value but greater than the third threshold value, the lighting compensation step size is the third step size. When the illuminance difference signal is less than the difference between the third threshold value and the illuminance of the target area, the lighting compensation step size is the fourth step size. Moreover, the first step size is greater than the second step size, the second step size is greater than the third step size, and the third step size is greater than the fourth step size. Therefore, the constant illuminance lighting control device 1 can achieve fine, stepless dimming, resulting in a very smooth brightness change for the lighting device 2. Consequently, the constant illuminance lighting control device can effectively improve the illumination performance of the lighting device 2.

Additionally, the lighting device 2 can execute the automatic adjustment mode. When the lighting device 2 performs the automatic adjustment mode, the brightness of the lighting device 2 can change appropriately, keeping the illuminance difference between the target area and the target illuminance always less than the preset difference value. Thus, the illuminance of the target area can remain at a constant illuminance state over time, meeting the user's needs.

The embodiment just exemplifies the present invention and is not intended to limit the scope of the present invention; any equivalent modification and variation according to the spirit of the present invention is to be also included within the scope of the following claims and their equivalents.

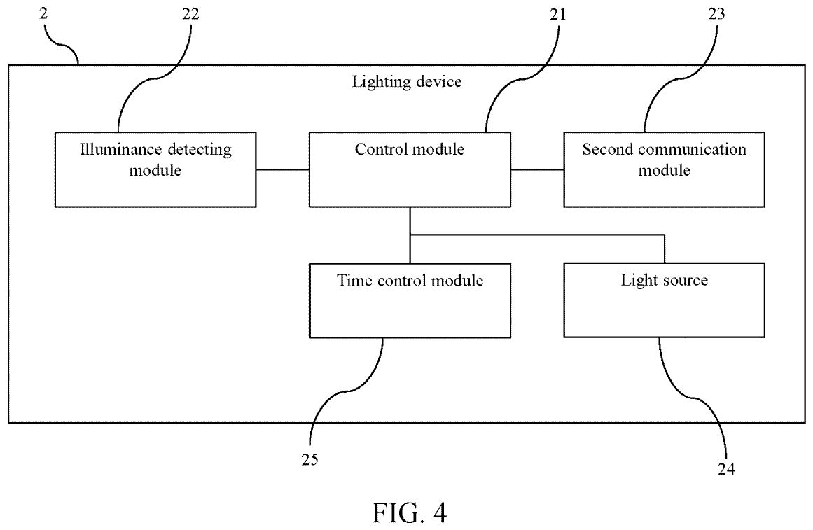

Please refer to FIG. 4, which is a block diagram of a constant illuminance lighting control device in accordance with a second embodiment of the present invention. As shown in FIG. 4, the lighting device 2 includes an illuminance detecting module 22, a control module 21, a second communication module 23, and a light source 24.

The above-mentioned elements are similar to those in the previous embodiment, and therefore will not be described in detail here. The difference between this embodiment and the previous embodiment is that the lighting device 2, in this embodiment, further includes a time control module 25. In one embodiment, the time control module may include a timer, an electronic clock circuit, or other similar components. The control module 21 can actively adjust the brightness of the lighting device 2 according to the settings of the time control module 25 in a preset variation mode. Consequently, the brightness of the lighting device 2 can vary with the ambient brightness, ensuring that the illuminance of the target area remains constant. In another embodiment, the control module 21 can actively adjust the brightness of the lighting device 2 according to the settings of the time control module 25 in a preset variation pattern, allowing the illuminance of the target area to follow a specific variation pattern. In this way, the lighting device 2 can meet the requirements of various applications.

The embodiment just exemplifies the present invention and is not intended to limit the scope of the present invention; any equivalent modification and variation according to the spirit of the present invention is to be also included within the scope of the following claims and their equivalents.

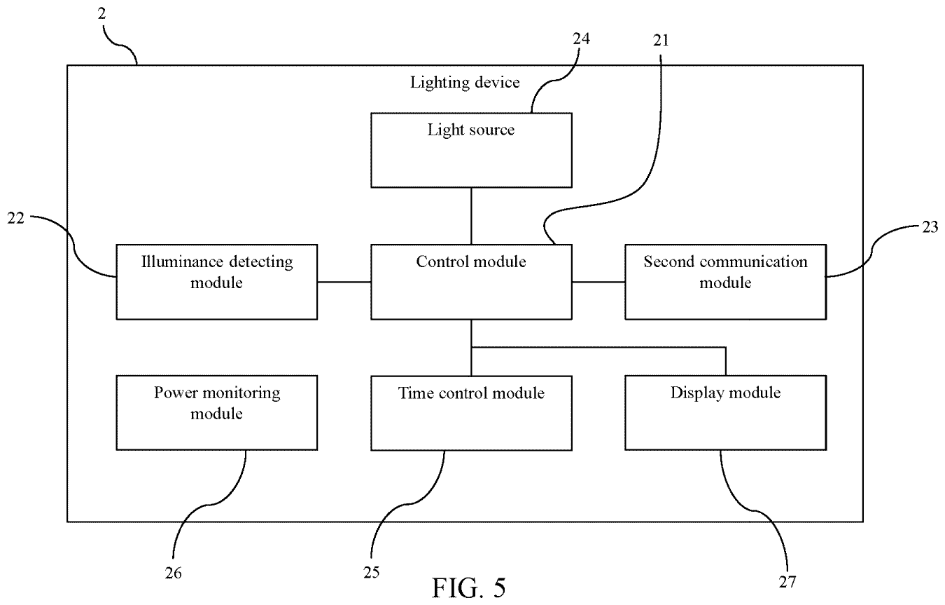

Please refer to FIG. 5, which is a block diagram of a lighting device in accordance with the second embodiment of the present invention. As shown in FIG. 5, the lighting device 2 includes an illuminance detecting module 22, a control module 21, a second communication module 23, a light source 24, and a time control module 25.

The above-mentioned elements are similar to those in the previous embodiments, and therefore will not be described in detail here. The difference between this embodiment and the previous embodiment is that the lighting device 2, in this embodiment, further includes a power monitoring module 26 and a display module 27. The power monitoring module 26 and the display module 27 are connected to the control module 21. In one embodiment, the power monitoring module 26 may include a voltage detection circuit, a current detection circuit, or other similar components. In one embodiment, the display module 27 may be a liquid crystal display, a touch screen, or other similar components. The control module 21 can obtain the operational status information (such as current and voltage) of the lighting device 2 via the power monitoring module 26 and display the aforementioned operational status information via the display module 27. Thus, the user can directly access information regarding the energy consumption and other necessary details of the lighting device 2, and take timely measures when the lighting device 2 operates abnormally.

The embodiment just exemplifies the present invention and is not intended to limit the scope of the present invention; any equivalent modification and variation according to the spirit of the present invention is to be also included within the scope of the following claims and their equivalents.

It is worthy to point out that currently available constant illuminance lighting solutions primarily rely on sensors installed on lighting devices to control dimming. However, due to environmental or other influencing factors, these solutions are still unable to effectively maintain a stable constant illuminance in the target area, failing to meet actual requirements. By contrast, according to one embodiment of the present invention, the constant illuminance lighting control device includes a light detecting module and a processing module. The light detecting module detects the illuminance of a target area, and the illuminance of the target area is provided by a lighting device. The processing module includes a signal register, and stores a dimming signal corresponding to the illuminance of the target area to serve as an initial dimming signal. The processing module executes a dimming signal tracking program to compare the illuminance of the target area with a target illuminance to generate an illuminance difference signal, and calculates a lighting compensation step size according to the illuminance difference signal. The processing module further generates a real-time dimming signal according to the lighting compensation step size, transmits the real-time dimming signal to the lighting device for dimming, and stores the real-time dimming signal in the signal register to replace the initial dimming signal. The dimming signal tracking program is repeatedly executed until the illuminance of the target area is substantially equal to the target illuminance. As described above, the constant illuminance lighting control device can execute a special dimming signal tracking program to enable the real-time dimming signal to track the dimming signal corresponding to the target illuminance with extremely small step sizes, which can achieve stepless dimming. Therefore, the constant illuminance lighting control device can achieve high performance to meet actual requirements.

According to one embodiment of the present invention, the constant illuminance lighting control device features a multi-step adjustment mechanism. When the illuminance difference signal exceeds a first threshold value, the lighting compensation step size is a first step size, wherein when the illuminance difference signal is less than the first threshold value but greater than a second threshold value, the lighting compensation step size is a second step size, wherein when the illuminance difference signal is less than the second threshold value but greater than a third threshold value, the lighting compensation step size is a third step size, wherein when the illuminance difference signal is less than a difference between the third threshold value and the illuminance of the target area, the lighting compensation step size is a fourth step size. Thus, the constant illuminance lighting control device can achieve precise stepless dimming, ensuring extremely smooth brightness transitions in the lighting device. Therefore, the constant illuminance lighting control device can effectively enhance the lighting effect of the lighting device. The first step size is greater than the second step size. The second step size is greater than the third step size. The third step size is greater than the fourth step size. Thus, the constant illuminance lighting control device can achieve precise stepless dimming, ensuring extremely smooth brightness transitions in the lighting device. Therefore, the constant illuminance lighting control device can effectively enhance the lighting effect of the lighting device.

Also, according to one embodiment of the present invention, the lighting device can also execute an automatic adjustment mode. When the lighting device executes the automatic adjustment mode, the brightness thereof can appropriately vary to ensure that the illuminance difference between the target area and the target illuminance remains below a preset difference value. Consequently, the illuminance of the target area can be maintained at a constant illuminance state over an extended period so as to be the requirements of the user.

Further, according to one embodiment of the present invention, the lighting device can also include a time control module, enabling the control module of the lighting device to actively adjust the brightness thereof in a preset variation pattern according to the settings of the time control module. As a result, the brightness of the lighting device can vary with changes in ambient lighting in order to make sure that the illuminance of the target area remains constant or follows a specific variation pattern. Thus, the lighting device can satisfy the requirements of various applications.

Moreover, according to one embodiment of the present invention, the lighting device can also include a power monitoring module and a display module. Consequently, the control module of the lighting device can obtain operational status information such as current and voltage via the power monitoring module and display this information via the display module. This allows the user to directly access the energy consumption and other necessary details of the lighting device and take timely measures in case of operational anomalies.

Furthermore, according to one embodiment of the present invention, the design of the constant illuminance lighting control device and the lighting device is simple, achieving the desired effects without significantly increasing costs. Therefore, the constant illuminance lighting control device and the lighting device both demonstrate high practicality and align with future development trends. As described above, the constant illuminance lighting control device according to the embodiments of the present invention can achieve great technical effects.

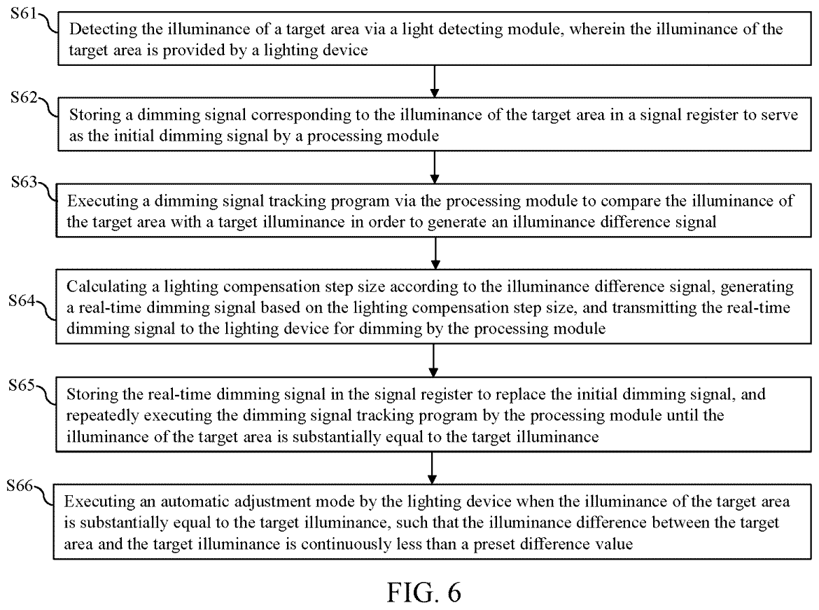

Please refer to FIG. 6, which is a flowchart of a constant illuminance lighting control method in accordance with a fourth embodiment of the present invention. As shown in FIG. 6, the constant illuminance lighting control method of the embodiment includes the following steps:
Step S61: detecting the illuminance of a target area via a light detecting module, wherein the illuminance of the target area is provided by a lighting device.
Step S62: storing a dimming signal corresponding to the illuminance of the target area in a signal register to serve as the initial dimming signal by a processing module.
Step S63: executing a dimming signal tracking program via the processing module to compare the illuminance of the target area with a target illuminance in order to generate an illuminance difference signal.
Step S64: calculating a lighting compensation step size according to the illuminance difference signal, generating a real-time dimming signal based on the lighting compensation step size, and transmitting the real-time dimming signal to the lighting device for dimming by the processing module.
Step S65: storing the real-time dimming signal in the signal register to replace the initial dimming signal, and repeatedly executing the dimming signal tracking program by the processing module until the illuminance of the target area is substantially equal to the target illuminance.
Step S66: executing an automatic adjustment mode by the lighting device when the illuminance of the target area is substantially equal to the target illuminance, such that the illuminance difference between the target area and the target illuminance is continuously less than a preset difference value.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the constant illuminance lighting control device includes a light detecting module and a processing module. The light detecting module detects the illuminance of a target area, and the illuminance of the target area is provided by a lighting device. The processing module includes a signal register, and stores a dimming signal corresponding to the illuminance of the target area to serve as an initial dimming signal. The processing module executes a dimming signal tracking program to compare the illuminance of the target area with a target illuminance to generate an illuminance difference signal, and calculates a lighting compensation step size according to the illuminance difference signal. The processing module further generates a real-time dimming signal according to the lighting compensation step size, transmits the real-time dimming signal to the lighting device for dimming, and stores the real-time dimming signal in the signal register to replace the initial dimming signal. The dimming signal tracking program is repeatedly executed until the illuminance of the target area is substantially equal to the target illuminance. As described above, the constant illuminance lighting control device can execute a special dimming signal tracking program to enable the real-time dimming signal to track the dimming signal corresponding to the target illuminance with extremely small step sizes, which can achieve stepless dimming. Therefore, the constant illuminance lighting control device can achieve high performance to meet actual requirements.

According to one embodiment of the present invention, the constant illuminance lighting control device features a multi-step adjustment mechanism. When the illuminance difference signal exceeds a first threshold value, the lighting compensation step size is a first step size, wherein when the illuminance difference signal is less than the first threshold value but greater than a second threshold value, the lighting compensation step size is a second step size, wherein when the illuminance difference signal is less than the second threshold value but greater than a third threshold value, the lighting compensation step size is a third step size, wherein when the illuminance difference signal is less than a difference between the third threshold value and the illuminance of the target area, the lighting compensation step size is a fourth step size. Thus, the constant illuminance lighting control device can achieve precise stepless dimming, ensuring extremely smooth brightness transitions in the lighting device. Therefore, the constant illuminance lighting control device can effectively enhance the lighting effect of the lighting device. The first step size is greater than the second step size. The second step size is greater than the third step size. The third step size is greater than the fourth step size. Thus, the constant illuminance lighting control device can achieve precise stepless dimming, ensuring extremely smooth brightness transitions in the lighting device. Therefore, the constant illuminance lighting control device can effectively enhance the lighting effect of the lighting device.

Also, according to one embodiment of the present invention, the lighting device can also execute an automatic adjustment mode. When the lighting device executes the automatic adjustment mode, the brightness thereof can appropriately vary to ensure that the illuminance difference between the target area and the target illuminance remains below a preset difference value. Consequently, the illuminance of the target area can be maintained at a constant illuminance state over an extended period so as to be the requirements of the user.

Further, according to one embodiment of the present invention, the lighting device can also include a time control module, enabling the control module of the lighting device to actively adjust the brightness thereof in a preset variation pattern according to the settings of the time control module. As a result, the brightness of the lighting device can vary with changes in ambient lighting in order to make sure that the illuminance of the target area remains constant or follows a specific variation pattern. Thus, the lighting device can satisfy the requirements of various applications.

Moreover, according to one embodiment of the present invention, the lighting device can also include a power monitoring module and a display module. Consequently, the control module of the lighting device can obtain operational status information such as current and voltage via the power monitoring module and display this information via the display module. This allows the user to directly access the energy consumption and other necessary details of the lighting device and take timely measures in case of operational anomalies.

Furthermore, according to one embodiment of the present invention, the design of the constant illuminance lighting control device and the lighting device is simple, achieving the desired effects without significantly increasing costs. Therefore, the constant illuminance lighting control device and the lighting device both demonstrate high practicality and align with future development trends.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A constant illuminance lighting control device, comprising:
a light detecting module configured to detect an illuminance of a target area, wherein the illuminance of the target area is provided by a lighting device; and
a processing module comprising a signal register and configured to store a dimming signal corresponding to the illuminance of the target area in the signal register to serve as an initial dimming signal;
wherein the processing module is configured to execute a dimming signal tracking program to compare the illuminance of the target area with a target illuminance to generate an illuminance difference signal, and calculates a lighting compensation step size according to the illuminance difference signal, wherein the processing module is configured to further generate a real-time dimming signal according to the lighting compensation step size, transmit the real-time dimming signal to the lighting device for dimming, and store the real-time dimming signal in the signal register to replace the initial dimming signal, wherein the dimming signal tracking program is repeatedly executed until the illuminance of the target area is substantially equal to the target illuminance.

2. The constant illuminance lighting control device as claimed in claim 1, wherein when the illuminance difference signal exceeds a first threshold value, the lighting compensation step size is a first step size, wherein when the illuminance difference signal is less than the first threshold value but greater than a second threshold value, the lighting compensation step size is a second step size, wherein when the illuminance difference signal is less than the second threshold value but greater than a third threshold value, the lighting compensation step size is a third step size, wherein when the illuminance difference signal is less than a difference between the third threshold value and the illuminance of the target area, the lighting compensation step size is a fourth step size.

3. The constant illuminance lighting control device as claimed in claim 2, wherein the first step size is greater than the second step size, the second step size is greater than the third step size, and the third step size is greater than the fourth step size.

4. The constant illuminance lighting control device as claimed in claim 2, wherein the first step size is 1.1 to 1. 6 times the second step size, the second step size is 1.2 to 2 times the third step size, and the third step size is 2.5 to 6.5 times the fourth step size.

5. The constant illuminance lighting control device as claimed in claim 1, wherein when the illuminance of the target area is substantially equal to the target illuminance, the lighting device executes an automatic adjustment mode, whereby an illuminance difference between the illuminance of the target area and the target illuminance is continuously less than a preset difference value.

6. A constant illuminance lighting control method, comprising:
detecting an illuminance of a target area via a light detecting module, wherein the illuminance of the target area is provided by a lighting device;
storing a dimming signal corresponding to the illuminance of the target area in a signal register to serve as the initial dimming signal by a processing module;
executing a dimming signal tracking program via the processing module to compare the illuminance of the target area with a target illuminance in order to generate an illuminance difference signal;
calculating a lighting compensation step size according to the illuminance difference signal, generating a real-time dimming signal based on the lighting compensation step size, and transmitting the real-time dimming signal to the lighting device for dimming by the processing module; and
storing the real-time dimming signal in the signal register to replace the initial dimming signal, and repeatedly executing the dimming signal tracking program by the processing module until the illuminance of the target area is substantially equal to the target illuminance.

7. The constant illuminance lighting control method as claimed in claim 6, wherein when the illuminance difference signal exceeds a first threshold value, the lighting compensation step size is a first step size, wherein when the illuminance difference signal is less than the first threshold value but greater than a second threshold value, the lighting compensation step size is a second step size, wherein when the illuminance difference signal is less than the second threshold value but greater than a third threshold value, the lighting compensation step size is a third step size, wherein when the illuminance difference signal is less than a difference between the third threshold value and the illuminance of the target area, the lighting compensation step size is a fourth step size.

8. The constant illuminance lighting control method as claimed in claim 7, wherein the first step size is greater than the second step size, the second step size is greater than the third step size, and the third step size is greater than the fourth step size.

9. The constant illuminance lighting control method as claimed in claim 7, wherein the first step size is 1.1 to 1.6 times the second step size, the second step size is 1.2 to 2 times the third step size, and the third step size is 2.5 to 6.5 times the fourth step size.

10. The constant illuminance lighting control method as claimed in claim 6, further comprising:
executing an automatic adjustment mode by the lighting device when the illuminance of the target area is substantially equal to the target illuminance, whereby an illuminance difference between the target area and the target illuminance is continuously less than a preset difference value.
